(19) United States
(12) Patent Application Publication
(10) Pub. No.: US 2022/0391840 A1
(43) Pub. Date: Dec. 8, 2022

(54) SYSTEMS AND METHODS FOR SMART DEPOSITORY

(71) Applicant: Saybrook Restructuring Advisors, LLC, Los Angeles, CA (US)

(72) Inventors: Jonathan Rosenthal, Los Angeles, CA (US); Brian James Smith, Avondale, PA (US)

(21) Appl. No.: 17/833,509

(22) Filed: Jun. 6, 2022

Related U.S. Application Data
(60) Provisional application No. 63/197,900, filed on Jun. 7, 2021.

(51) Int. Cl. G06Q 10/08; G06Q 10/00

(52) U.S. Cl. CPC G06Q 10/0836; G06Q 10/30

(57) ABSTRACT

A modular item depository includes: two or more modular depository units, each modular depository unit including: a plurality of storage areas comprising lockable one or more doors for accessing or placing items therein, and one or more processors including memory and communication interface for wireless communication with a plurality of electronic devices; an interface module for providing power, heating or cooling to the plurality of storage areas in each modular depository unit; a camera for taking an image when the one or more doors are opened or closed, wherein the one or more processors are configured to receive verification of the user as an authorized user and when the user is verified as an authorized user, enable the user interface to receive inputs from the authorized user; and a user interface for receiving inputs from a user to open the one or more doors for accessing items stored therein.

### CROSS-REFERENCE TO RELATED APPLICATIONS

This Patent Application claims the benefits of U.S. Provisional Patent Application Ser. No. 63/197,900, filed on Jun. 7, 2021 and entitled “Systems and Methods for Smart Depository,” the entire content of which is hereby expressly incorporated by reference.

### FIELD OF THE INVENTION

The disclosed invention generally relates to item depositories, and more particularly to transportable, modular, wireless, internet-enabled, smart depositories.

### BACKGROUND

Inefficiencies are present in the typical parcel delivery system, for example, inefficiencies in “last mile” parcel delivery, as well as, the high cost of labor to receive, sort, distribute and monitor incoming parcels. The present embodiments may provide for substantial reduction in the cost of last mile delivery and pick up, since the depository allows for bulk drops. More specifically, bulk drops remove the inefficiency of delivering to each resident, whether each resident lives in a multi-family or single-family environment. The depository may also be used in a retail environment for afterhours pick up and drop off. The consolidation of pick-up and delivery nodes will reduce millions of transit miles, traffic congestion, and wasted labor. The depository may also provide for discarding corrugated boxes that may otherwise clog dumpsters, residential trash bins, and landfills.

### SUMMARY

In some embodiments, the disclosure is directed to a modular item depository. The depository includes two or more modular depository units, where each modular depository unit includes: a plurality of storage areas comprising lockable one or more doors for accessing or placing items therein, and one or more processors including memory and communication interface for wireless communication with a plurality of electronic devices. The depository further includes an interface module for providing power, heating or cooling to the plurality of storage areas in each modular depository unit; a camera for taking an image when the one or more doors are opened or closed, wherein the one or more processors are configured to receive verification of the user as an authorized user and when the user is verified as an authorized user, enable the user interface to receive inputs from the authorized user; and a user interface for receiving inputs from a user to open the one or more doors for accessing items stored therein. In some embodiments, the depository unit is designed to maintain constant parcel custody and control, using cameras to record the deposit and retrieval of parcels which data is archived for security, tracking and analysis.

In some embodiments, the disclosure is directed to a modular item depository. The depository includes two or more modular depository units, where each modular depository unit further includes: a plurality of storage areas comprising lockable one or more doors for accessing or placing items therein, and one or more processors including memory and communication interface for wireless communication with a plurality of electronic devices. The depository further includes an autonomous conveyer/elevator controlled by the one or more processors for autonomously picking up the item from or drop the item in a storage area; a camera for taking an image when the one or more doors are opened or closed; and a user interface for receiving inputs from a user to open the one or more doors for accessing items stored therein.

In some embodiments, the depository further includes a delivery mechanism for delivering or re-routing an item to a destination depository. In some embodiments, the delivery mechanism includes a drone in communication with the one or more processors for picking up or dropping off the item in a storage area.

### BRIEF DESCRIPTION OF THE DRAWINGS

The components in the figures are not necessarily to scale, emphasis instead being placed upon illustrating the principals of the invention. Like reference numerals designate corresponding parts throughout the different views. Embodiments are illustrated by way of example and not limitation in the figures of the accompanying drawings, in which:

FIG. 1 depicts a schematic of a system for delivery of a smart and transportable depository, according to some embodiments of the disclosure.

FIG. 2 shows a schematic of communication pathways between a subscriber, a control center, and a transportable depository, according to some embodiments of the disclosure.

FIG. 3 illustrates a modular, perspective view of a transportable depository, for example, the depository of FIG. 2.

FIG. 4 shows a perspective view of a transportable depository, according to some embodiments of the disclosure.

FIG. 5 illustrates a perspective view of a transportable depository, according to some embodiments of the disclosure.

FIG. 6 depicts a modular, perspective view of a detached transportable depository, for example, the transportable depository of FIG. 5 detached.

FIG. 7 illustrates an exemplary top-level functional block diagram of a computing device embodiment, according to some embodiments of the disclosure.

FIG. 8 shows a high-level block diagram and process of a computing system or implementing some embodiments of the system and process, according to some embodiments of the disclosure.

FIG. 9 shows a block diagram and process of an exemplary system in which some embodiments may be implemented, according to some embodiments of the disclosure.

FIG. 10 depicts a cloud computing environment, according to some embodiments of the disclosure.

### DETAIL DESCRIPTION

Some embodiments of the disclosure are related to one or more methods, systems, apparatuses, and mediums storing computer-executable process steps for a standalone transportable depository (e.g., a pod) for smart, internet enabled, modularized, temperature-controlled, last meter parcel delivery and recycling.

In some embodiments, the depository may include a subscription service, where a subscriber (for example, for a monthly, annual or per-use fee) may deposit or direct items to any other depository in the network. In some embodiments, the subscriber (user) may direct, for example, groceries, package, and items, such as a parcel bearing the name and address of the any other depository in the network in order to be routed through delivery services, such as the postal service or by express package delivery services. When a delivery occurs, the subscriber may be notified by a notification (e.g., transmitted by the processor), such as an alert, a text or email to the subscriber's smart device. In some embodiments, the depository may include a plurality of (physical) storage spaces (e.g., storage boxes), each individually programmable and accessible by one or more subscribers.

In some embodiments, the system may select a facial recognition module, or coded identification for accessing the depository for item pick-up or drop off. In some embodiments, the system may include one or more wireless cameras and a photographic evidence of the item being deposited and/or picked up may be produce automatically or based on a request by the subscriber (who drops the item and/or the one who picks it up). In some embodiments, the depository recognizes a subscriber approaching by reference to the subscriber's mobile device (for example, by a sensor sensing the identification of the mobile device and strength of the signal or location of the mobile device, when that mode of recognition has been selected by the subscriber. The depository may receive user's information (including account and authentication information) from the mobile device while the user is approaching (within a predetermined distance) the depository. As such, a full complement of delivery information may be sent to the subscriber, with customizable data. Reminders may be sent periodically to the subscriber until the parcel is retrieved for its final destination or to be routed to other depositories in the network.

The subscriber's depository may also be used for parcel returns, e.g., “reverse logistics”, of outbound parcels. In some embodiments, the depository may be temperature controlled to accommodate perishable goods, such as groceries. In some embodiments, the depository may be self-contained and may be used for both indoor and outdoor applications. More specifically, the depository is weatherproof and designed for inclement weather. Additionally, the depository may incorporate recycling features, such as a trash compactor function for recycling of discarded corrugated boxes.

The techniques and processes described below may be implemented by programmable circuitry programmed or configured by software and/or firmware, or entirely by special-purpose circuitry, or in a combination of such forms. Such special-purpose circuitry (if any) can be in the form of, for example, one or more integrated circuits (ICs) application-specific integrated circuits (ASICs), programmable logic devices (PLDs), field-programmable gate arrays (FPGAs), etc.

In some embodiments, the software and/or firmware is executed by a processing circuit. The term “processing circuit” is used herein to mean any combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed circuit board (PCB) or distributed over several interconnected PCBs. A processing circuit may contain other processing circuits; for example, a processing circuit may include two processing circuits, an FPGA and a CPU, interconnected on a PCB.

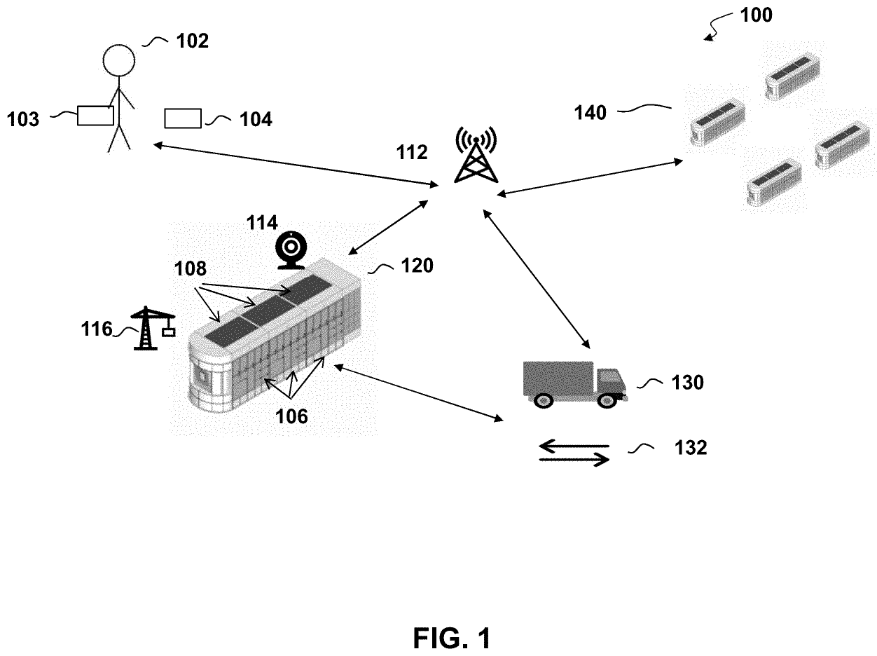

FIGS. 1-20 and the following discussion provide a general description of a suitable computing environment in which aspects of the described technology may be implemented. Although not required, aspects of the technology may be described herein in the general context of computer-executable instructions, such as routines executed by a general- or special-purpose data processing device (e.g., a server or client computer). Aspects of the technology described herein may be stored or distributed on tangible computer-readable media, including magnetically or optically readable computer discs, hard-wired or preprogrammed chips (e.g., EEPROM semiconductor chips), or other data storage media. Alternatively, computer-implemented instructions, data structures, screen displays, and other data related to the technology may be distributed over the Internet or over other networks (including wireless networks) on a propagated signal on a propagation medium (e.g., an electromagnetic wave, a sound wave, etc.) over a period of time. In some implementations, the data may be provided on any analog or digital network (e.g., packet-switched, circuit-switched, or other scheme).

The described technology may also be practiced in distributed computing environments where tasks or modules are performed by remote processing devices, which are linked through a communications network, such as a Local Area Network (LAN), Wide Area Network (WAN), or the Internet. In a distributed computing environment, program modules or subroutines may be located in both local and remote memory storage devices. Those skilled in the relevant art will recognize that portions of the described technology may reside on a server computer, while corresponding portions may reside on a client computer (e.g., processing circuit, PC, mobile computer, tablet, or smart phone). Data structures and transmission of data particular to aspects of the technology are also encompassed within the scope of the described technology.

In some embodiments, the depository includes one or more storage areas including one or more doors for accessing parcels stored therein; one or more interface modules comprising a touchscreen configured to receive at least one of: a code to open the one or more doors and a facial recognition to open the one or more doors; and one or more recycling components comprising a trash compactor for recycling of discarded corrugated boxes from the one or more parcels.

FIG. 1 depicts a schematic of a system for delivery of a smart and transportable depository, according to some embodiments of the disclosure. As depicted, a system 100 for a standalone, transportable smart depository 120 is illustrated. The system 100 may include a subscriber 102, at least one deliverable item 104, the smart depository 120, a delivery vehicle 130 (e.g., truck, van, car, boat, drone and the like) or delivery mechanism 132 and a network of depositories 140, all of which are capable of wireless communication via a wireless network 112, such as Internet or any other communication network. In some embodiments, the depository 120 includes a plurality of safe storage areas 106, for example, locked storage boxes that are individually accessible by the subscribers. In some embodiments, the delivery mechanism 132 be a conveyor belt, a system of pipes, elevators, drones and the like for delivering or re-routing the items 104 to a nearby destination depository (for example, one or more of the depositories 140).

In some embodiments, the network manages locker capacity so if the subscriber's primary locker/box is full or the subscribers doesn't have a locker that is the appropriate size, then the item is redirected to the subscriber's #2 or #3 alternative locker/box nearby, for example, based on his/her profile information that may include one or more alternative lockers/boxes.

In some embodiments, the depository 120 includes one or more wireless cameras 114 that take pictures or videos of a drop off or pickup operation by the subscribers, for example, for providing evidence of the drop-off or pickup. The cameras 114 may be triggered automatically or upon activation by a subscriber. The captured picture or video may be transmitted (for example, via the wireless network 112) to a remote (central) destination or stored in a storage medium within the depository 120, for future access. In some embodiments, the depository 120 is a smart, internet-enabled, modularized, temperature-controlled that may include a plurality of solar panels 108 for providing power to the smart depository 120 and safe storage areas 106, last meter parcel delivery and corrugated cardboard recycling. In some embodiments, cameras 114 may be positioned inside or outside of each (or a group of) safe storage areas 106.

In some embodiments, the depository 120 may include a subscription service, where the subscriber 102 may direct items, such as the deliverable item 104 to any other depository in the network 140. In some embodiments, the subscriber 102 may direct the item 104, such as groceries or a parcel bearing the name and address of the any other depositories in the network 130 in order to be routed through delivery services, such as the postal or other package delivery services, or by delivery mechanism 132. In some embodiments, the depository 120 may be transported with delivery vehicle 130 and placed at desired locations for item drop-offs or pickups. When a delivery occurs with the delivery vehicle 130 or the delivery mechanism 132, the subscriber 102 may be notified by an alert, such as a text or email to a smart device of the subscriber 103. The alert may include an image (or video) of the item being dropped or picked up.

In some embodiments, the delivery vehicle 130 maybe an unmanned aerial vehicle (UAV) or a drone communicating with the processor that is capable land on an area of the depository 120 and automatically picking up or dropping off an item in the depository 120 (for example, in a safe storage area 106) via an autonomous conveyer/elevator 116. For example, when the drone lands on a designated area of the depository 120, a sensor senses the presence (and position) of the drone and activates the autonomous conveyer/elevator 116 to take the item from the drone and transport the item to an unlocked storage area, (optionally, message the camera 114 to take an image of the delivered item) and let the system know that the item has been safely and securely stored and is ready for a pickup or re-route to a different depository (140). Conversely, when the drone lands on the designated area of the depository 120, the sensor senses the presence (and position) of the drone and activates the autonomous conveyer/elevator 116 to deliver the item to the drone from an unlocked safe storage area and transport the item to the drone (and optionally, activate the camera 114 to take an image of the picked up item) and let the system know that the item has been safely picked up and is on its way for delivery to a destination depository 140. The system can then transmit a verification message regarding the status of the item, lock the unlocked storage area and go back to its initial state

In some embodiments, the depository 120 utilizes a facial recognition module or coded identification for item pick-up from or drop-off. Also, the subscriber 102 may also request photographic evidence of the parcel 104 being deposited in the depository 120 (or any of safe storage areas 106) the and picked up. As such, a full complement of delivery information may be sent to the subscriber 102, with customizable data. Additionally, reminders may be sent periodically to the subscriber 102 until the parcel 104 is retrieved by other depositories in the network 140. The subscriber's 102 depository 120 may also be used for parcel returns, e.g., “reverse logistics” of outbound parcels.

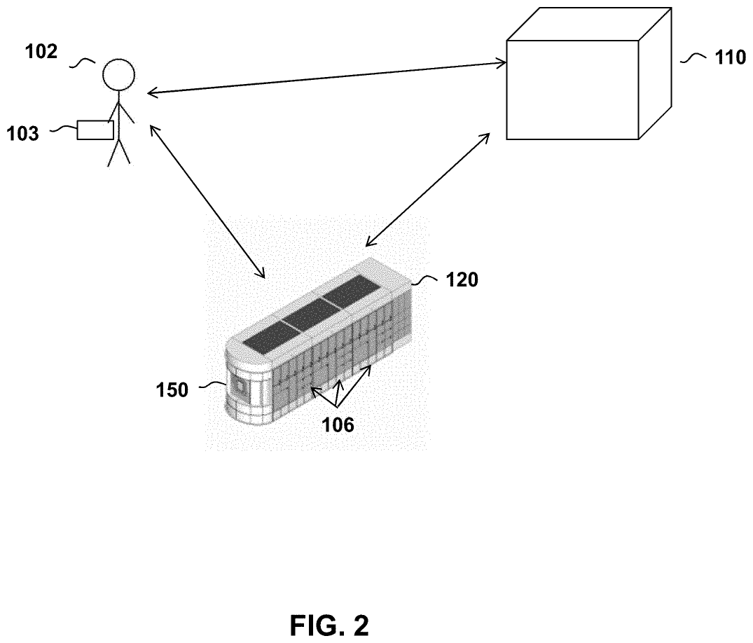

FIG. 2 shows a schematic of communication pathways between a subscriber, a control center, and a transportable depository, according to some embodiments of the disclosure. As shown, communication pathways between a subscriber 102, a mobile device 103 and a depository 120 are controlled and managed by a control center 110 (e.g., including one or more server computers). In some embodiments, the subscriber 102 may communicate directly with the depository 120, such as with a user interface 150, for example, a touchscreen of the depository 120. For example, the depository 120 may have a numerical code for unlocking (or locking) of and other interfaces with one or more of the safe storage areas 106 of the depository 120 with the user interface 150. In some embodiments, the subscriber 102 may transmit the code to the depository 120 via the mobile device 103 to unlock the depository 120. The user interface 150 provides for user-friendly communication of various commands, status, messaging and the like for the subscriber 102 with the depository 120 and safe storage areas 106, by a touch screen, keyboard, voice recognition, biometric recognition, barcode scanning, or a combination thereof.

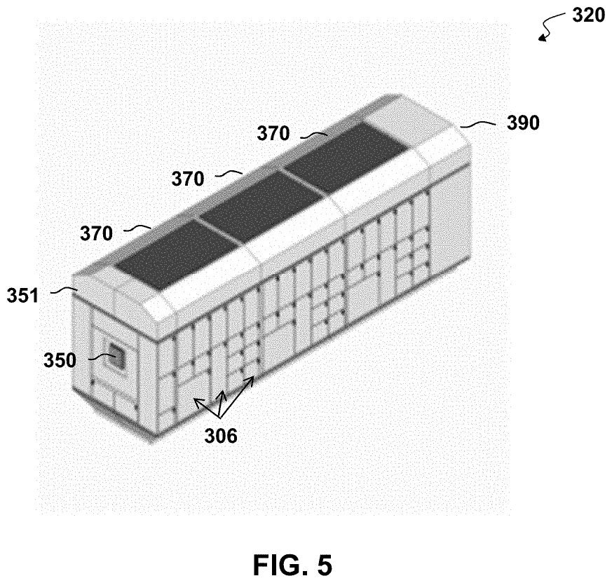

In some embodiments, the subscriber 102 may communicate with the central control center 110 and/or the depository 120 via the mobile device 103. In some embodiments, the central control center 110 controls the operation and functionality of the depository 120. In some embodiments, the control center 110 may be a cloud computing environment, such as cloud computing environment 50 of FIG. 5, described below. The cloud computing environment may comprise one or more cloud computing nodes with which local computing devices (e.g., servers) used by cloud consumers, such as, for example, subscriber 102 and the mobile device 103. In some embodiments, the local computing devices may include a personal digital assistant (PDA), smartphone, smart watch, set-top box, video game system, tablet, desktop computer, laptop computer, and/or automobile computer system. The nodes may communicate with one another, and may be grouped physically or virtually, in one or more networks, such as Private, Community, Public, or Hybrid clouds. This allows the cloud computing environment to communicate with the depository 120 and the subscriber 102, over the wireless network 112, such the Internet. In some embodiments, the control center 110 may include a stack infrastructure as a service (IaaS), a platform as a service (PaaS), serverless, and software as a service (SaaS).

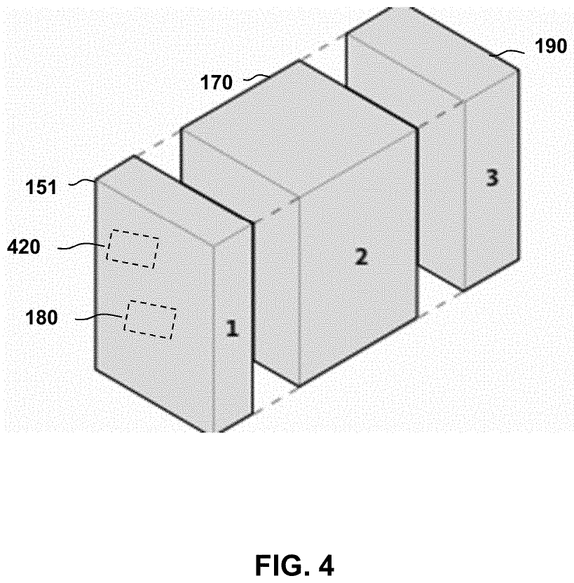

The depository 120 may further include a processing circuit, such as computing device 420 described in FIG. 4. The computing device 420 may provide for smart communication between the depository 120 and the control center 110, and with the subscriber 102 and the computing device 103 of the subscriber 102. The computing device 420 may also provide the control functions of the depositor 120, such as locking and unlocking of the safe storage areas 106, various sensors, cameras 114, conveyer/elevator 116 and interface to delivery mechanism 132.

In some embodiments, the subscriber 102 may select, at the user interface 150 of the depository 120 or at the mobile device 103, a facial recognition function or coded identification for parcel 104 pick-up or drop-off upon receipt or drop-off of the deliverable item 104. The subscriber 102 may also request photographic evidence of the parcel 104 being deposited in or picked up from the depository 120. As such, a full complement of delivery information may be sent to the subscriber 102 via the control center 110 or directly from the depository 120, with customizable data and various reports. Additionally, reminders may be sent periodically to the subscriber 102 until the parcel 104 is retrieved by other depositories in the network 140. The subscriber's 102 depository 120 may also be used for parcel returns, e.g., “reverse logistics”, of outbound parcels.

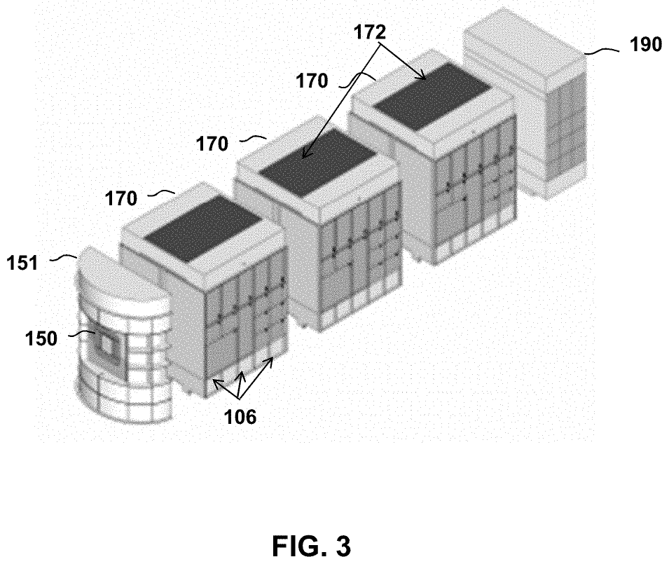

FIG. 3 illustrates a modular, perspective view of a modular and transportable depository, for example, the depository of FIG. 2. As shown, the depository 120 may be comprised of as plurality of modular depository units 170. Each modular depository unit 170 may be a self-supporting depository unit that may be added onto or subtracted from by a user's subscription. In some embodiments, each modular depository unit 170 may be also be modular with respect to the number of storage areas 106. For example, different number of storage areas 106 can be stacked up and arranged for each modular depository unit 170. Similarly, different number of modular depository units 170 can be stacked up and arranged for each depository 120. Once two or more modular depository units 170 are set up (e.g., connected) together, the processing circuits of each start communicating with each other and configure themselves to operate as a combined depository unit.

In some embodiments, the depository 120 may be used in multi-family housing developments, parking garages, outdoor lots, and the like, using a desired size of the depository by incorporating a certain number of modular depository units 170 therein. Integrated within the depository 120 is infrastructure for receiving additional elements, such as a canopy system, solar panels, cooling and heating elements and trash management systems. In some embodiments, the depository 120 may be modular with at least three modular depository units 170, an interface module 151, and a recycling component 190.

The storage areas 170 may be further integrated with batteries, lighting, and solar panels. In some embodiments, the storage areas 170 may include lighting and/or branding opportunity above and below the storage areas 170. The storage areas 270 may further include a caster system for ease of transportation and placement. In some embodiments, the storage areas 170 may be temper-controlled and the storage areas 170 may be interchanged as needed. In some embodiments, the storage areas 170 may be app-enabled with authenticated locker doors.

In some embodiments, the depository 120 may incorporate recycling features with the recycling component 190, such as a trash compactor function for recycling of discarded recyclable packages and corrugated boxes. In some embodiments, the recycling component 190 may include digital and physical branding elements, as well as illuminated frame elements with integrated storage for servicing, charging station and display. The recycling component 190 may further include a trash baler and recycling bin compartments with secure access to bins for maintenance. In some embodiments, the recycling component 190 may further include a caster system for ease of transportation and placement. In some embodiments, the recycling component 190 may accommodate a canopy attachment.

The storage areas 106 of the depository 120 may further include at least one secure door for access to the contents of the depository 120, such as the parcel 104 or refrigerated, temperature-controlled groceries. In some embodiments, the receiver of the depository 120 may receive a code from the control center 110 to enter at the touchscreen 150 in order to open the door and access the contents of the delivered depository 120. In some embodiments, the door may open for the receiver of the depository 120 after facial recognition of the receiver is provided. In some embodiments, the system checks to authenticate a user as a valid subscriber and once the user is authenticated, a code may be sent to the user to open/close the doors. The interface module 150 may further include a charging station and display, as well as security and facial recognition cameras with associated software, for example, camera 114 in FIG. 1, for recognizing and authenticating the user.

The interface module 150 of depository 120 may further include a caster system for ease of transportation and placement of the depository 120. In some embodiments, the interface module 150 may accommodate a canopy attachment as a cover to provide shade or other environmental protections, as well as back-lighting with translucent, fritted, and/or colored panels behind frame element for safety and branding.

In some embodiments, depository 120 may be a self-supporting unit that may be added onto or subtracted from subscription, by a user. In some embodiments, the depository 120 may be used in multi-family housing developments, parking garages, outdoor lots, and the like. Integrated within the depository 120 is infrastructure for receiving additional elements, such as a canopy system, solar panels, and trash management systems. In some embodiments, the depository may be modular with at least 3 principal modules and an interface module 150, storage areas 106, solar panels 172 and a recycling component 190.

FIG. 4 shows a perspective view of a transportable depository, according to some embodiments of the disclosure. As shown, the interface module 151 may include a user interface 150, for example, a touchscreen, keyboard, voice recognition, biometric recognition, barcode scanning, or a combination thereof. The interface module 151 may also house the computing device 420, and a temperature control component 180. In some embodiments, the touchscreen 150 may be a digital, app-enabled user interface for package retrieval and outgoing parcels. In some embodiments, the depository 120 may be self-contained and may be used for both indoor and outdoor applications. In some embodiments, the depository 120 may be made with stainless steel, titanium, carbon fiber, and/or another durable (light) material. In some embodiments, the interface module 151 may also house a computing device 420, charging station, security camera and a temperature control component 180.

In some embodiments, the storage areas 106 (FIGS. 1-3) may be further integrated with batteries, lighting, and solar panels. In some embodiments, the storage areas 106 may include lighting and/or digital and physical branding elements or other signage above and below the storage areas 106. The modular depository units 170 may include a caster system for ease of transportation and placement. In some embodiments, the modular depository units 170 may accommodate a canopy attachment running along the top of the depository. In some embodiments, the storage areas 106 may be temper-controlled and the modular depository units 170 may be interchanged as needed. In some embodiments, the storage areas 106 may be app-enabled with authenticated locker doors. In some embodiments, the depository 120 may approximately 19 feet 4 inches in length, the interface module 151 being 2 feet long, each modular depository unit being 5 feet long, and the recycling component 190 being 2 feet 4 inches long. In some embodiments, the depository 120 is 6 feet 10 inches tall, and 5 feet 3 inches wide. In some embodiments, each storage area may be 2 feet tall and 2 feet wide.

FIG. 5 illustrates a perspective view of a transportable depository, according to some embodiments of the disclosure. Like depository 120 and depository 220, depository 320 may be a self-supporting unit that may be added onto or subtracted from by a user. In some embodiments, the depository 320 may be used in multi-family housing developments, parking garages, outdoor lots, and the like. Integrated within the depository 320 is infrastructure for receiving additional elements, such as a canopy system, solar panels, and trash management systems. In some embodiments, the depository 320 is modular with at least 3 modular depository units 370, each including a plurality of storage spaces 306.

Depository 320 also includes an interface module 351, at least one storage area 370, and a recycling component 390. In some embodiments, the depository 320 may incorporate recycling features with the recycling component 390, such as a trash compactor function for recycling of discarded corrugated boxes. The storage areas 306 of the depository 320 may further include at least one door for access to the contents of the depository 320, such as the parcel 304 or refrigerated, temperature-controlled groceries. In some embodiments, the receiver of the depository 320 may receive a code from the control center 310 to enter at the touchscreen 350 in order to open the door 392 and access the contents of the delivered depository 320. In some embodiment, the door may open for the receiver of the depository 320 after facial recognition of the receiver is provided.

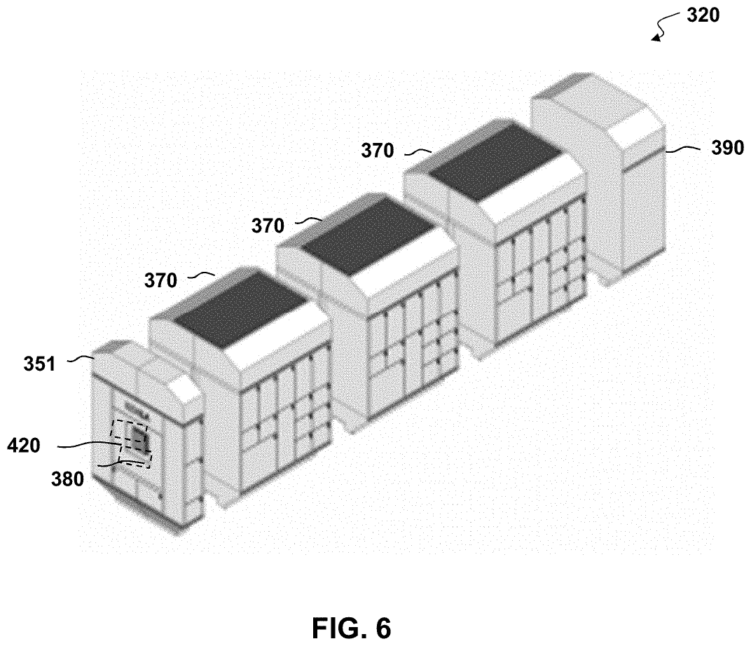

FIG. 6 depicts a modular, perspective view of a transportable depository, for example, the transportable depository of FIG. 5. As shown, the interface module 351 may include a user interface 350 at a user interface, such as user interface 429. The interface module 351 may also house the computing device 420, and a temperature control component 380. In some embodiments, the depository 320 may be temperature-controlled with the temperature control component 380 to accommodate perishable goods, such as groceries. In some embodiments, the user interface 350 may be a digital, app-enabled user interface for package retrieval and outgoing parcels.

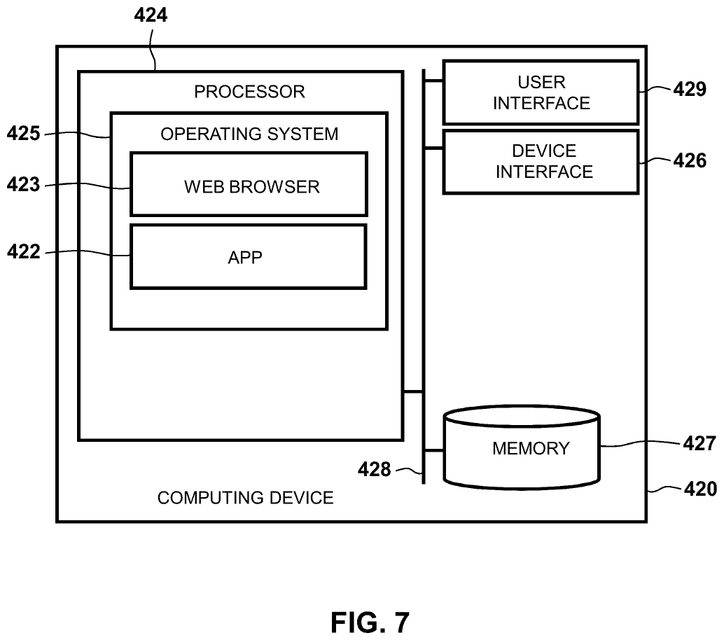

FIG. 7 illustrates an exemplary top-level functional block diagram of a computing device 420, according to some embodiments of the disclosure. As depicted, the computing device 420 includes a processor 424, such as a central processing unit (CPU), addressable memory 427, an external device interface 426, e.g., an optional universal serial bus port and related processing, and/or an Ethernet port and related processing, and an optional user interface 429, e.g., an array of status lights and one or more toggle switches, and/or a display, and/or a keyboard and/or a pointer-mouse system and/or a touch screen.

Optionally, the addressable memory may include any type of computer-readable media that can store data accessible by the computing device 420, such as magnetic hard and floppy disk drives, optical disk drives, magnetic cassettes, tape drives, flash memory cards, digital video disks (DVDs), Bernoulli cartridges, RAMs, ROMs, smart cards, including a connection port to or node on a network, such as a LAN, WAN, or the Internet. These elements may be in communication with one another via a data bus 428. In some embodiments, via an operating system 425 such as one supporting a web browser 423 and applications 422, the processor 424 may be configured to execute steps of a process establishing a communication channel and processing according to the embodiments described above.

In some embodiments, the computing device 420 stores the information and data about the subscriber(s) and all the related transactions related to the user and the depository 120 in a blockchain in the memory 427. For example, the blockchain maybe configured as a transaction-based state machine. Beginning with a “lock” state, this state transitions into an “unlock” state when an item is about to be dropped off or pick up. The state may then transition into a “verification” state, such as taking a picture or a video, a “transmission/confirmation” state to send and/store a verification of the item being dropped off or pick up, and back to the “lock” state. In some embodiments, the transactions are grouped into “blocks”, and each block is chained together with its previous block in the blockchain structure in the memory 427. In some embodiments, all of subscriber/user information (including account and transaction histories) are stored in the cloud and are accessible by the users.

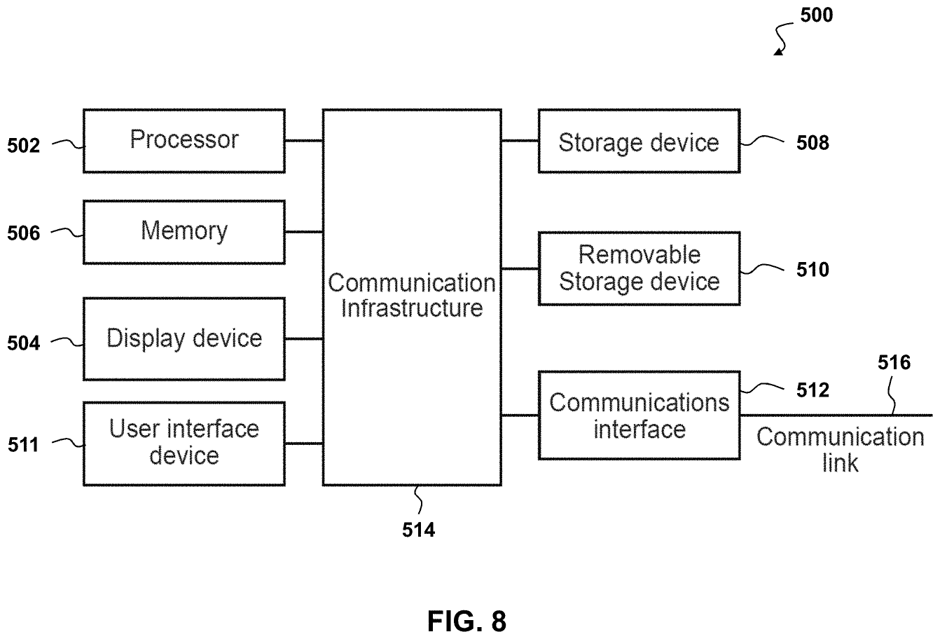

FIG. 8 shows a high-level block diagram and process of a computing system for implementing some embodiments of the system and process, according to some embodiments of the disclosure. As depicted, a computing system 500 implements some embodiments of the system and process, disclosed herein. Embodiments of the system may be implemented in different computing environments. The computer system 400 may include one or more processors 502, and can further include an electronic display device 504 (e.g., for displaying graphics, text, and other data), a main memory 506 (e.g., random access memory (RAM)), storage device 508, a removable storage device 510 (e.g., removable storage drive, a removable memory module, a magnetic tape drive, an optical disk drive, a computer readable medium having stored therein computer software and/or data), user interface device 511 (e.g., keyboard, touch screen, keypad, pointing device), and a communication interface 512 (e.g., modem, a network interface (such as an Ethernet card), a communications port, or a PCMCIA slot and card). The communication interface 512 allows software and data to be transferred between the computer system and external devices. The system further includes a communications infrastructure 514 (e.g., a communications bus, cross-over bar, or network) to which the aforementioned devices/modules are connected as shown.

Information transferred via communications interface 514 may be in the form of signals such as electronic, electromagnetic, optical, or other signals capable of being received by communications interface 514, via a communication link 516 that carries signals and may be implemented using wire or cable, fiber optics, a phone line, a cellular/mobile phone link, an radio frequency (RF) link, and/or other communication channels. Computer program instructions representing the block diagram and/or flowcharts herein may be loaded onto a computer, programmable data processing apparatus, or processing devices to cause a series of operations performed thereon to produce a computer implemented process.

Embodiments have been described with reference to flowchart illustrations and/or block diagrams of methods, apparatus (systems) and computer program products according to embodiments. Each block of such illustrations/diagrams, or combinations thereof, can be implemented by computer program instructions. The computer programs (i.e., computer control logic) are stored in main memory and/or secondary memory. Computer programs may also be received via a communications interface 512. Such computer programs, when executed, enable the computer system to perform the features of the embodiments as discussed herein. In particular, the computer programs, when executed, enable the processor and/or multi-core processor to perform the features of the computer system. Such computer programs represent controllers of the computer system.

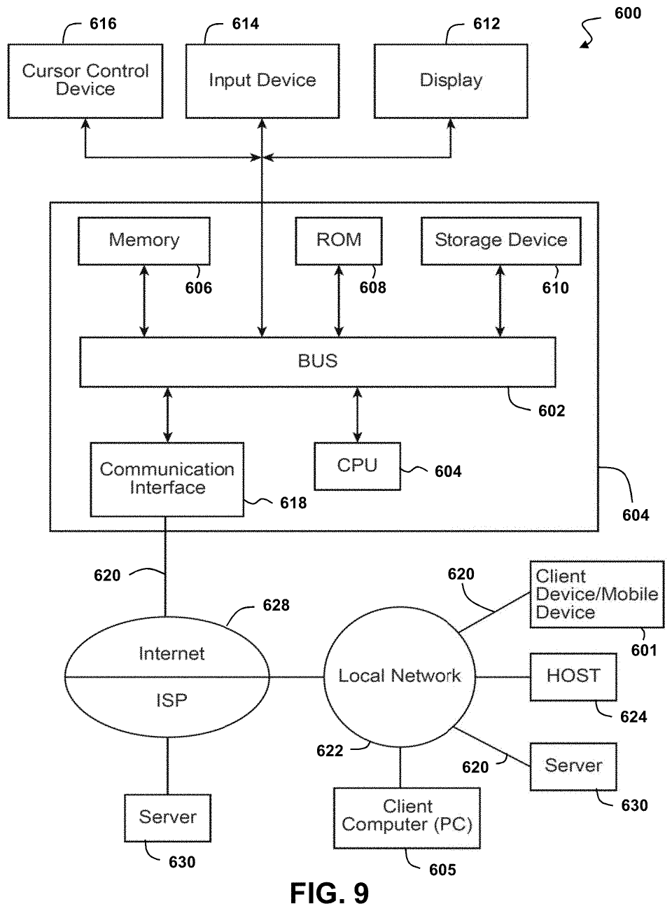

FIG. 9 shows a block diagram and process of an exemplary system in which some embodiments may be implemented, according to some embodiments of the disclosure. The system 600 includes one or more client devices 601 such as consumer electronics devices, connected to one or more server computing systems 630. A server 630 includes a bus 602 or other communication mechanism for communicating information, and a processor (CPU) 604 coupled with the bus 602 for processing information. The server 630 also includes a main memory 606, such as a random-access memory (RAM) or other dynamic storage device, coupled to the bus 602 for storing information and instructions to be executed by the processor 604. The main memory 606 also may be used for storing temporary variables or other intermediate information during execution or instructions to be executed by the processor 604. The server computer system 630 further includes a read only memory (ROM) 608 or other static storage device coupled to the bus 602 for storing static information and instructions for the processor 604.

A storage device 610, such as a magnetic disk or optical disk, is provided and coupled to the bus 602 for storing information and instructions. The bus 602 may contain, for example, thirty-two address lines for addressing video memory or main memory 606. The bus 602 can also include, for example, a 32-bit data bus for transferring data between and among the components, such as the CPU 604, the main memory 606, video memory and the storage 610. Alternatively, multiplex data/address lines may be used instead of separate data and address lines.

The server 630 may be coupled via the bus 602 to a display 612 for displaying information to a computer user. An input device 614, including alphanumeric and other keys, is coupled to the bus 602 for communicating information and command selections to the processor 604. Another type or user input device comprises cursor control 616, such as a mouse, a trackball, or cursor direction keys for communicating direction information and command selections to the processor 604 and for controlling cursor movement on the display 612.

According to some embodiments, the functions are performed by the processor 604 executing one or more sequences of one or more instructions contained in the main memory 606. Such instructions may be read into the main memory 606 from another computer-readable medium, such as the storage device 610. Execution of the sequences of instructions contained in the main memory 606 causes the processor 604 to perform the process steps described herein. One or more processors in a multi-processing arrangement may also be employed to execute the sequences of instructions contained in the main memory 606. In alternative embodiments, hard-wired circuitry may be used in place of or in combination with software instructions to implement the embodiments. Thus, embodiments are not limited to any specific combination of hardware circuitry and software.

The server 630 also includes a communication interface 618 coupled to the bus 602. The communication interface 618 provides a two-way data communication coupling to a network link 620 that is connected to the world-wide packet data communication network now commonly referred to as the Internet 628. The Internet 628 uses electrical, electromagnetic or optical signals that carry digital data streams. The signals through the various networks and the signals on the network link 620 and through the communication interface 618, which carry the digital data to and from the server 630, are exemplary forms or carrier waves transporting the information.

In some embodiments of the server 630, interface 618 may be connected to a network 622 via a communication link 620. For example, the communication interface 618 may be an integrated service digital network (ISDN) card or a modem to provide a data communication connection to a corresponding type of telephone line, which can comprise part of the network link 620. As another example, the communication interface 618 may be a local area network (LAN) card to provide a data communication connection to a compatible LAN. Wireless links may also be implemented. In any such implementation, the communication interface 618 sends and receives electrical electromagnetic or optical signals that carry digital data streams representing various types of information.

The network link 620 typically provides data communication through one or more networks to other data devices. For example, the network link 620 may provide a connection through the local network 622 to a host computer 624 or to data equipment operated by an Internet Service Provider (ISP). The ISP in turn provides data communication services through the Internet 628. The local network 622 and the Internet 628 both use electrical, electromagnetic or optical signals that carry digital data streams. The signals through the various networks and the signals on the network link 620 and through the communication interface 618, which carry the digital data to and from the server 630, are exemplary forms or carrier waves transporting the information.

The server 630 can send/receive messages and data, including e-mail, program code, through the network, the network link 620 and the communication interface 618. Further, the communication interface 618 can comprise a USB/Tuner and the network link 620 may be an antenna or cable for connecting the server 630 to a cable provider, satellite provider or other terrestrial transmission system for receiving messages, data and program code from another source.

Similar to a server 630 described above, a client device 601 can include a processor, memory, storage device, display, input device and communication interface (e.g., e-mail interface) for connecting the client device to the Internet 628, the ISP, or LAN 622, for communication with the servers 630.

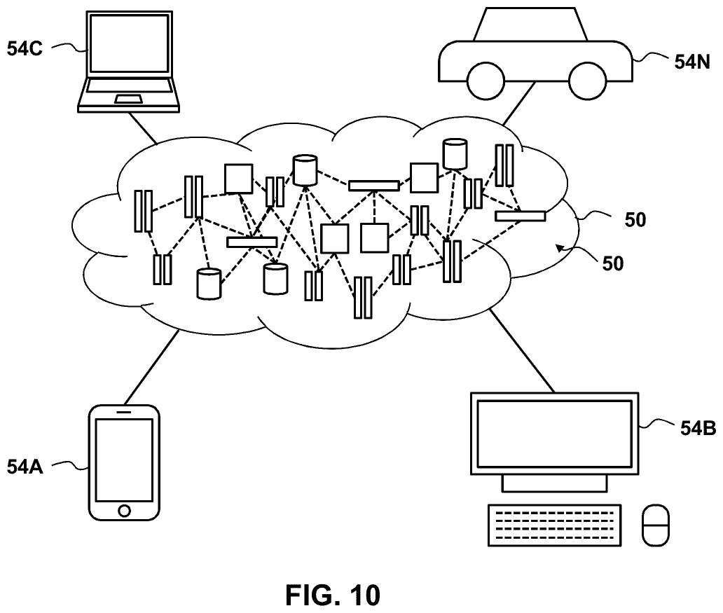

Referring now to FIG. 10, illustrative cloud computing environment 50 is depicted. As shown, cloud computing environment 50 comprises one or more cloud computing nodes 10 with which local computing devices used by cloud consumers, such as, for example, personal digital assistant (PDA), smartphone, smart watch, set-top box, video game system, tablet, mobile computing device, or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 20 are intended to be illustrative only and that computing nodes 10 and cloud computing environment 50 can communicate with any type of computerized device over any type of network and/or network addressable connection (e.g., using a web browser).

In some embodiments, the process flow of the depository is as follow:

Subscriber downloads the depository application on their smart mobile device.

Subscriber completes profile application, including credit card, billing information, preferences, facial imprint (optional).

Subscriber selects a “Home” depository location for delivery.

Subscriber selects an “office” or “school” depository location for delivery.

Subscriber selects 2 alternate locations for delivery when lockers are not available at Home.

Recipient selects a depository location and locker for a delivery.

Payload is shipped to depository by Sender. For example, system message to recipient—>“package in route.”

Delivery is executed by Sender to locker(s) and the Sender and/or depository system creates a log of successful delivery (and photo/video is archived) and transaction (from Sender side) is closed. For example, the system messages to recipient—>“package delivered.”

Recipient gains exclusive physical access to locker(s) in depositor.

Massages, such as, text message and/or email to recipient's authorized address(es) provide to the recipient a (software) key or code to access the shipped payload.

Pickup is completed, locker(s) sealed, and interaction is documented with photo/video and a log of the activities and other related information.

It is contemplated that various combinations and/or sub-combinations of the specific features and aspects of the above embodiments may be made and still fall within the scope of the invention. Accordingly, it should be understood that various features and aspects of the disclosed embodiments may be combined with or substituted for one another in order to form varying modes of the disclosed invention. Further, it is intended that the scope of the present invention is herein disclosed by way of examples and should not be limited by the particular disclosed embodiments described above.

What is claimed is:

1. A modular item depository comprising:
two or more modular depository units, each modular depository unit including:
a plurality of storage areas comprising lockable one or more doors for accessing or placing items therein, and
one or more processors including memory and communication interface for wireless communication with a plurality of electronic devices;
an interface module for providing power, heating or cooling to the plurality of storage areas in each modular depository unit;
a camera for taking an image when the one or more doors are opened or closed, wherein the one or more processors are configured to receive verification of the user as an authorized user and when the user is verified as an authorized user, enable the user interface to receive inputs from the authorized user; and
a user interface for receiving inputs from a user to open the one or more doors for accessing items stored therein.

2. The modular item depository of claim 1, further comprising a recycling device comprising a trash compactor for recycling of discarded materials.

3. The modular item depository of claim 1, further comprising a delivery mechanism for delivering or re-routing an item to a destination depository.

4. The modular item depository of claim 3, wherein the delivery mechanism includes a drone in communication with the one or more processors for picking up or dropping off the item in a storage area.

5. The modular item depository of claim 4, further comprising a sensor, wherein when the drone lands on a designated area of the modular item depository, the sensor senses the presence of the drone and activates a conveyer/elevator to take the item from the drone and transport the item to an unlocked storage area.

6. The modular item depository of claim 4, further comprising a sensor, wherein when the drone lands on a designated area of the modular item depository, the sensor senses the presence of the drone and activates a conveyer/elevator to transport the item to the drone from an unlocked safe storage area.

7. The modular item depository of claim 3, wherein the delivery mechanism includes one or more of a conveyor, a system of pipes, and an elevator.

8. The modular item depository of claim 1, further comprising an autonomous conveyer/elevator controlled by the one or more processors for autonomously picking up the item from or drop the item in a storage area.

9. The modular item depository of claim 1, wherein the one or more processors transmit a notification to the user, when the item is delivered to the modular item depository or when the item is picked up from the modular item depository.

10. The modular item depository of claim 1, further comprising a facial recognition camera for recognizing and authenticating the user.

11. The modular item depository of claim 1, further comprising a mobile sensor for sensing identification of a mobile device of the user and strength of a signal or a location of the mobile device, as the use approaches the modular item depository to recognize the user.

12. The modular item depository of claim 11, wherein the one or more processors receive user's information including account and authentication information from the mobile device, when the user is approaching the modular item depository.

13. The modular item depository of claim 1, wherein the user interface includes one or more of a touchscreen, a keyboard, voice recognition, biometric recognition and barcode scanning.

14. The modular item depository of claim 1, further comprising a blockchain for storing information and data about a plurality of users and all transactions related to the plurality of users,

15. The modular item depository of claim 14, wherein the blockchain is configured as a transaction-based state machine, and wherein transactions are grouped into blocks in the blockchain and each block is chained together with its previous block in the blockchain.

16. A modular item depository comprising:
two or more modular depository units, each modular depository unit including:
a plurality of storage areas comprising lockable one or more doors for accessing or placing items therein, and
one or more processors including memory and communication interface for wireless communication with a plurality of electronic devices;
an autonomous conveyer/elevator controlled by the one or more processors for autonomously picking up the item from or drop the item in a storage area;
a camera for taking an image when the one or more doors are opened or closed; and
a user interface for receiving inputs from a user to open the one or more doors for accessing items stored therein.

17. The modular item depository of claim 16, further comprising a delivery mechanism for delivering or re-routing an item to a destination depository.

18. The modular item depository of claim 17, wherein the delivery mechanism includes a drone in communication with the one or more processors for picking up or dropping off the item in a storage area.

19. The modular item depository of claim 17, further comprising a sensor, wherein when the drone lands on a designated area of the modular item depository, the sensor senses the presence of the drone and activates a conveyer/elevator to take the item from the drone and transport the item to an unlocked storage area.

20. The modular item depository of claim 16, wherein the one or more processors transmit a notification to the user, when the item is delivered to the modular item depository or when the item is picked up from the modular item depository.
